(19) United States
(12) Patent Application Publication
(10) Pub. No.: US 2009/0272487 A1
(43) Pub. Date: Nov. 5, 2009

(54) Method for manufacturing multi-image labels

(76) Inventor: Jason Grossman, Petaluma, CA (US)

Correspondence Address: Ralph C. Francis;Francis Law Group, 1942 Embarcadero, Oakland, CA, 94606, US

(21) Appl. No.: 12/386,711

(22) Filed: Apr. 21, 2009

Related U.S. Application Data
(60) Provisional application No. 61/126,172, filed on May 1, 2008.

(51) Int. Cl. B32B 38/14

(52) U.S. Cl. 156/277

(57) ABSTRACT

A method for manufacturing a multi-image label, comprising substantially continuously (i) printing a first image on a first side of a first substantially planar label element, (ii) affixing the first side of the first label element to the second side of a second substantially planar label element, and (iii) printing a second image on the first side of the second label element.

### CROSS-REFERENCE TO RELATED APPLICATIONS

This application claims the benefit of U.S. Provisional Application No. 61/126,172, filed May 1, 2008.

### FIELD OF THE PRESENT INVENTION

The present invention relates generally to methods and apparatus for manufacturing substantially planar elements or sheets, such as labels. More particularly, the invention relates to an improved method for manufacturing multi-image labels in a continuous, rapid operation.

### BACKGROUND OF THE INVENTION

There are a variety of industries in which substantially planar elements or sheets, such as labels, must be manufactured at high rates of speed, but where the cost of such manufacture and the limitations inherent in conventional methods and apparatus severely restrict manufacture. For example, the label manufacturing industry produces labels that are typically sold in rolls, consisting of a carrier or release sheet on which are adhesively, but releasably, arranged a multiplicity of labels. Typically, the purchasers of such rolls are manufacturers and/or packagers of products.

By way of illustration, bottlers or products, such as milk, often employ machines that accept such rolls of labels. The machines automatically and successively dispense labels from the rolls and individually apply the labels to the bottles or containers of milk in a predetermined orientation and location. The labels are, of course, printed to order for the bottler so as to contain information relating to the particular products to which they are to be applied.

Label manufacturers must have the capability of manufacturing labels of a multitude of different types so as be able to meet the ends of their customers. Thus, label manufacturers may be requested to produce labels of virtually any size and shape, of a variety of different materials, with printing that is exposed or buried beneath a lacquer transparent plastic film, as well as to provide labels having multiple surfaces or portions that can be torn off by the end purchaser for use as a coupon or the like. For example, in the bottling industry, where packaging, distribution and display of the bottles causes the bottles to abrade each other, it is desirable to use labels in which the printing is buried beneath and readable through a protective surface so that such printing is not worn off.

A further complication for label manufacturers resides in the fact that the adhesive employed to retain the labels on a carrier sheet and thereafter for retaining the label on the product are often slow to set or cure. Such curing is commonly too slow to permit the label manufacturers to produce their own laminated stock, print, die cut, strip the waste matrix from the carrier sheet and wind the carrier sheet bearing the resulting labels into a roll, all in a single continuous process.

As is well known in the art, the terms “pre-laminated stock” and “laminated stock” are often used to mean adhesively interconnected carrier and element sheets disposed in registry with each other to form a lamination, but not otherwise processed to form labels on the carrier sheet. Such pre-laminated stock is most commonly wound into a roll for storage, handling and subsequent processing to form labels.

Prior art efforts to form laminated stock, print, die cut and otherwise complete rolls of labels in a single continuous process have resulted in the adhesive migrating (prior to setting of the adhesive) beyond the peripheries of the labels during manufacture and thereafter. The adhesive migration can, and in many instances will, interfere with die cutting of the labels. Further, once the carrier sheet bearing the labels is wound into a roll, the adhesive often times continues to migrate beyond the peripheries of the labels, causing surfaces within the roll to stick together and, at very lest, interfere with dispensing of the labels from the carrier sheet.

Consequently, conventional practice calls for label manufacturers to buy pre-laminated stock, or manufacture it themselves and allow it to cure, in meeting their needs and those of their customers. The pre-laminated stock is thereafter printed and die cut to form the labels in accordance with the needs of those customers.

In view of the foregoing conventional practices, the manufacture labels of certain types have been fraught with difficulties, since printing was typically performed by the label manufacturer and pre-lamination of the stock performed by another company prior to receipt by the label manufacturer.

For example, it was often deemed impractable or not possible to produce labels in which the printing is captured on the reverse side of a transparent element sheet and thus between that element sheet and its carrier sheet. This is the case because conventional practice dictated that the printing be applied to the underside of the transparent element sheet in order to be visible through the element sheet and yet it was the manufacturer of the pre-laminated stock, not the label manufacturer, that was responsible for adhesively applying the element sheet to the carrier sheet. Referring again to the example of bottling companies, this made the production of buried print labels, wherein the printing is buried beneath and readable through a transparent film in order to protect the printing from scuffing by other bottles, impractical or inordinately expensive to produce.

A recent technique that has been employed by label manufacturers to produce buried print or image labels comprises printing a back image or lettering on a clear, plastic stock, disposing an opaque white layer on the opposite side of the clear stock, and printing a top image over the opaque white layer. Although the noted multi-image labels can be readily produced by a label manufacturer, the noted process has several significant limitations, including the provision of labels having one plastic layer. As is well known in the art, such labels are typically not very robust and do not provide a sophisticated appearance.

It would thus be desirable to provide an improved method of manufacturing multi-layered, multi-image labels in a continuous, rapid operation.

It is therefore an object of the present invention to provide an improved method of manufacturing multi-layered, multi-image labels in a continuous, rapid operation.

It is another object of the invention to provide a flexographic printing method for manufacturing multi-image labels in a continuous, rapid operation.

### SUMMARY OF THE INVENTION

In accordance with the above objects and those that will be mentioned and will become apparent below, the method for manufacturing a multi-image label, in accordance with this invention, generally includes the steps of substantially continuously (i) printing a first image on a first side of a first substantially planar label element, (ii) affixing the first side of the first label element to a second side of a second substantially planar label element, and (iii) printing a second image on the first side of the second label element.

In one embodiment of the invention, the first label element (or substrate) comprises a clear film and the second label element comprises paper stock.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a flow chart of one embodiment of the method to manufacture multi-image labels, according to the invention;

FIG. 2 is a flow chart of another embodiment of the method to manufacture multi-image labels, according to the invention;

FIG. 3 is an illustration of an image applied to a clear base element or substrate of a label, according to the invention; and

FIG. 4 is an illustration of an image applied to a top element of a label, according to the invention.

### DETAILED DESCRIPTION OF THE INVENTION

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “a label” includes two or more such labels.

As will be appreciated by one having ordinary skill in the art, the present invention substantially reduces or eliminates the disadvantages and shortcomings associated with prior art methods and apparatus for manufacturing multi-image labels. The invention, in one embodiment, generally comprises (i) providing a first substantially planar element having first and second sides, (ii) providing a second substantially planar element having first and second sides, and (iii) substantially continuously printing a first image on the first side of the first label element, affixing the first side of the first label element to the second side of the second label element, and printing a second image on the first side of the second label element. A key advantage of the invention is that each of the noted processing steps is performed substantially continuously, i.e. in one pass, during the printing process.

As will be appreciated by one having ordinary skill in the art, applying the images to the label elements can be accomplished by various conventional printing methods and processes, including flexographic printing processes, web off-set printing and Gravure printing. In a preferred embodiment of the invention, the images are applied to the label elements by a flexographic printing process. As is well known in the art, flexographic printing is a method of direct rotary printing that uses a resilient relief image in a plate of rubber or photopolymer to print images on a variety of substrates, such as films, foils, paper, paper-board stock and laminates.

Referring now to FIG. 1, there is shown a flow chart of one embodiment of the method to manufacture multi-image labels. In the noted embodiment, the method includes the steps of substantially continuously (i) printing a first image on a first side of a first substantially planar label element 10, (ii) affixing the first side of the first label element to a second side of a second substantially planar label element 12, and (iii) printing a second image on the first side of the second label element 14. As illustrated in FIG. 1, the method also includes the step of die-cutting the finished multi-layered, multi-image label 20.

In one embodiment of the invention, the first label element or substrate comprises a clear film. Preferably, the clear film comprises a composite film substrate having a clear film, adhesive and liner (or release sheet). According to the invention, the substrate liner can comprise a clear or paper stock.

In one embodiment, the second label element comprises paper stock. According to the invention, the paper stock can comprise various forms and thicknesses. In one embodiment of the invention, the paper stock employed as the second label element comprises a composite element having a liner, adhesive and paper face.

In the noted embodiment, a roll of the clear film, i.e. composite film substrate, is unwound and the first image is printed on a first side thereof 10, i.e. clear film, during which a roll of the composite paper element is similarly unwound and the paper stock (or paper layer) is separated from the liner and affixed to the clear film 12. The affixed composite element, i.e. composite film substrate and paper stock, is then directed to further print stations, wherein the desired second image is printed on the top of the paper stock 14. Thereafter, the affixed composite element is die cut, whereby the composite element, i.e. finished label, is disposed on the liner of the composite clear film substrate.

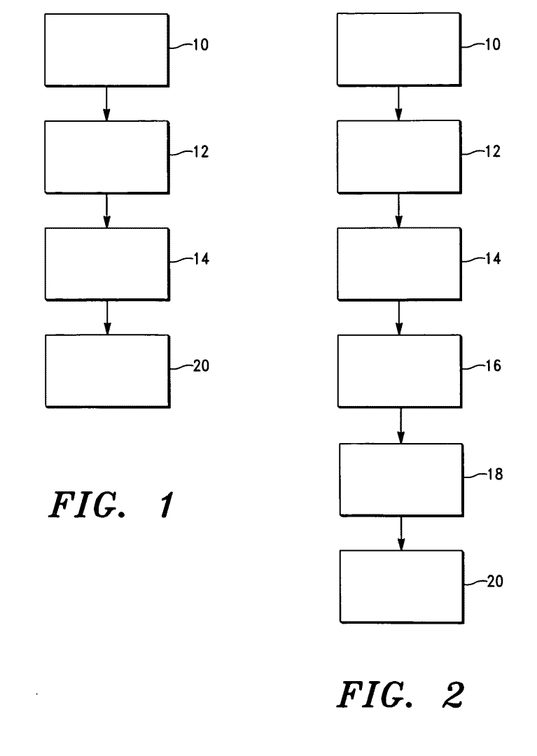

Referring now to FIG. 2, there is shown a flow chart of another embodiment of the method to manufacture multi-image labels. As illustrated in FIG. 2, the method similarly includes the steps of substantially continuously (i) printing a first image on a first side of a first substantially planar label element 10, (ii) affixing the first side of the first label element to a second side of a second substantially planar label element 12, (iii) printing a second image on the first side of the second label element 14, and die-cutting the finished multi-layered, multi-image label 20. However, in this embodiment, the method further includes the steps of foiling 16 and embossing 18 the label prior to die-cutting 20.

According to the invention, the first and second images can comprise various forms, such as logos and lettering. The first and second images can comprise and/or include a multitude of colors.

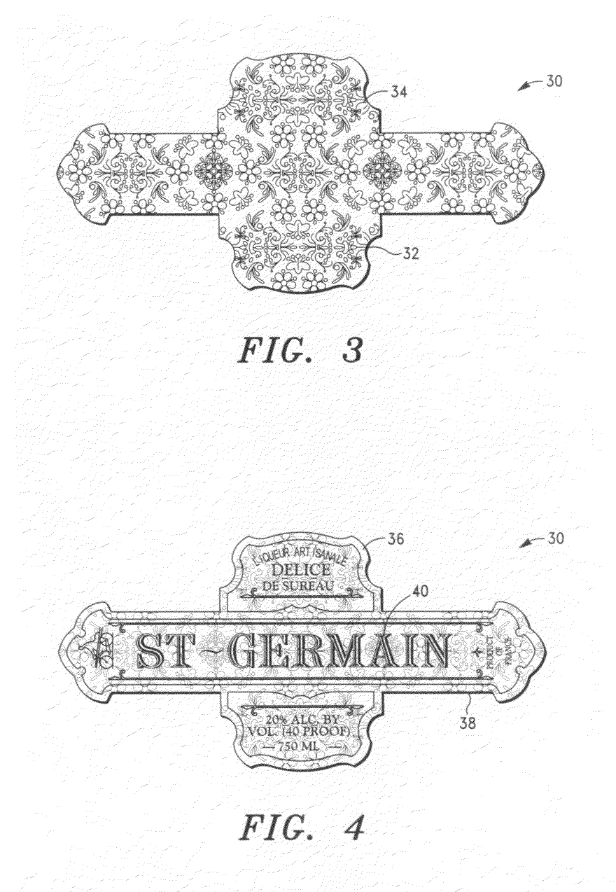

Referring now to FIGS. 3 and 4, there is shown an exemplar label 30 that was produced by the method of the invention. Referring first to FIG. 3, there is shown the first side of the clear film substrate 32, having the first image 34 printed thereon. In this instance, a clear substrate liner is used, whereby the image 34 is visible therethrough.

Referring now to FIG. 4, there is shown the face or first side of the paper stock 36, having the second image 38 printed thereon. As indicated, according to the invention, the first and second images 34, 38 can include a multitude of colors.

As will be appreciated by one having ordinary skill in the art, the present invention provides numerous advantages over prior art label printing methods. Among the advantages are the following:
The provision of a method of manufacturing multi-layered, multi-image labels in a continuous, rapid printing process.
The provision of a sophisticated multi-layered, multi-image label that exhibits all of the qualities of a plastic label and with the finish of a high quality paper label.
The provision of a robust and more durable composite, i.e. multi-layered, label.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A method of manufacturing a multi-image label, comprising the steps of:
providing a first substantially planar label element, said first label element having first and second sides;
providing a second substantially planar label element, said second label element having first and second sides; and
substantially continuously printing a first image on said first side of said first label element, affixing said first side of said first label element to said second side of said second label element, and printing a second image on said first side of said second label element.

2. The method of claim 1, wherein said first label element comprises a clear film and said second label element comprises paper stock.

3. The method of claim 2, wherein said first image is visible through said first label element.

4. The method of claim 1, including the step of die-cutting said affixed first and second label elements.
